(19) United States
(12) Patent Application Publication
(10) Pub. No.: US 2026/0239460 A1
(43) Pub. Date: Aug. 13, 2026

(54) NETWORKING COMMUNICATION METHOD AND PLATFORM IN AN INTERNET-FREE ENVIRONMENT

(71) Applicant: Fujian Baofeng Electronic Co., Ltd, Quanzhou (CN)

(72) Inventor: Shaofeng WANG, Quanzhou (CN)

(21) Appl. No.: 19/285,368

(22) Filed: Jul. 30, 2025

(30) Foreign Application Priority Data
Feb. 12, 2025 (CN) 202510154210.4

(51) Int. Cl. H04W 76/14; H04W 8/00; H04W 84/18

(52) U.S. Cl. CPC H04W 76/14; H04W 8/005; H04W 84/18

(57) ABSTRACT

The present application relates to a networking communication method and platform in an Internet-free environment, wherein the method includes: receiving a connection request form a user intelligent terminal, screening available intermediary terminals capable of establishing a Bluetooth connection with the user intelligent terminal, and each of the intermediary terminals is capable of communicating with other intermediary terminals based on a pre-constructed intercom network; obtaining target intermediary terminals from all the available intermediary terminals, and establishing a Bluetooth connection between each of the target intermediary terminals and the user intelligent terminal; receiving a communication request from the user intelligent terminal, executing the communication request through the target intermediary terminal, so as to transmit communication content to the user intelligent terminal for receiving the communication content through the intercom network.

### CROSS-REFERENCE TO RELATED APPLICATION

This application claims the priority to Chinese patent application serial no. 202510154210.4, filed on Feb. 12, 2025. The entirety of Chinese patent application serial no. 202510154210.4 is hereby incorporated by reference herein and made a part of this specification.

### TECHNICAL FIELD

The present application relates to a technical field of network communication, and in particular, to a networking communication method and platform in an Internet-free environment.

### BACKGROUND

With rapid development of social networks, social network users generally access the Internet by using PC terminals or mobile intelligent terminals, especially through WiFi connections, to achieve communication and information interaction over the Internet.

However, when users are in remote areas (such as mountainous regions) where corresponding geographical environment lacks traditional networks infrastructure such as WiFi, or even cellular signals, their electronic devices (such as mobile intelligent terminals) cannot use the Internet for communication and information transmission. In severe cases, communication failures may jeopardize user safety and property security, necessitating improvements to address this limitation.

### SUMMARY

In order to realize communication and information interaction in an Internet-free environment, the present application provides a networking communication method and platform in an Internet-free environment.

In a first aspect, the present application provides a networking communication method in an Internet-free environment, including:
receiving a first connection request from a first user intelligent terminal, and screening at least one available intermediary terminal capable of establishing a Bluetooth connection with the first user intelligent terminal from a plurality of intermediary terminals, wherein each of the plurality of intermediary terminals is configured to communicate with other intermediary terminals based on a pre-constructed intercom network;
obtaining target intermediary terminals from all available intermediary terminals, and establishing the Bluetooth connection between each of the target intermediary terminals and the first user intelligent terminal; and
receiving a communication request from the first user intelligent terminal, executing the communication request through the target intermediary terminal, so as to transmit communication content in the communication request to a second user intelligent terminal for receiving the communication content through the intercom network based on terminal information contained in the communication request;
wherein, the networking communication method further includes:
determining a communication frequency of a first intermediary terminal that has established the Bluetooth connection with the first user intelligent terminal, and determining whether the first intermediary terminal satisfies a sharing condition;
when the first intermediary terminal satisfies the sharing condition, designating the first intermediary terminal as one of second intermediary terminals, generating a connection object table for the second intermediary terminal, adding user intelligent terminals that have established the Bluetooth connections with the second intermediary terminal to the connection object table, and using the second intermediary terminal as an available intermediary terminal for real-time screening;
when the second intermediary terminal being screened as a target intermediary terminal after receiving a second connection request, adding a user intelligent terminal triggering the second connection request into the connection object table corresponding to the second intermediary terminal; and
determining in real time whether any user intelligent terminal in the connection object table has a communication demand, and switching the second intermediary terminal to establish the Bluetooth connection with a user intelligent terminal having the communication demand.

According to the above technical solution, in the environment without Internet support, Bluetooth is activated to establish connections between the user intelligent terminals and the intermediary terminals. Correspondingly, the intermediary terminals must be equipped with Bluetooth connection functions, and the present application defines that all intermediary terminals form the intercom network with each other. That is, all intermediary terminals can communicate with each other. Therefore, when two users cannot directly communicate through their respective user intelligent terminals, they can establish connections with intermediary terminals respectively, send the communication content to the intermediary terminals, and relay the corresponding communication content through the communication between the intermediary terminals, thereby indirectly realizing communication between the two users possessing intelligent terminals in the Internet-free environment. For the first intermediary terminal that has established the Bluetooth connection, the present application proposes determining whether the first intermediary terminal can be served as the second intermediary terminal satisfying the sharing condition based on the communication frequency of the user intelligent terminals currently connected thereto through the Bluetooth. That is, by utilizing a single second intermediary terminal to meet the communication requirements of a plurality of user intelligent terminals, meaningless occupation of intermediary terminal resources by idle user intelligent terminals with prolonged inactivity may be avoided, thereby improving communication utilization efficiency of the intermediary terminals. It should be emphasized that a second intermediary terminal can only perform Bluetooth communication with one unique user intelligent terminal at any given period, so as to realize orderly connection management of all user intelligent terminals in its connection object table.

In a second aspect, the present application provides a networking communication platform in the Internet-free environment, including:
an intermediary terminal screening module, configured to receive a first connection request from a first user intelligent terminal, screen at least one available intermediary terminal capable of establishing a Bluetooth connection with the first user intelligent terminal from a plurality of intermediary terminals, wherein each of the plurality of intermediary terminals is configured to communicate with other intermediary terminals based on a pre-constructed intercom network;
a terminal pairing connection module, configured to obtain target intermediary terminals from all available intermediary terminals and establish the Bluetooth connection between each of the target intermediary terminals and the first user intelligent terminal;
a terminal communication interaction module, configured to receive a communication request from the first user intelligent terminal, execute the communication requests through the target intermediary terminals, so as to transmit communication content in the communication request to a second user intelligent terminal for receiving the communication content through the intercom network based on terminal information contained in the communication request.

In summary, the present application includes the following beneficial technical effects: in this application, a communication connection is established between the intelligent terminal (such as a mobile phone) and an intermediary terminal via Bluetooth to form the intercom network, enabling communication in the Internet-free environment. This solution is suitable for emergency situations or remote areas, ensuring effective communication even without traditional network support.

### BRIEF DESCRIPTION OF THE DRAWINGS.

In order to more clearly illustrate the technical solutions in the embodiments of the present application, the accompanying drawings required for the description of the embodiments will be briefly introduced below. It is obvious that the drawings described below are only some embodiments of the present application, for those skilled in the art, other drawings can be obtained based on these drawings without creative labor.

FIG. 1 is a flowchart of a networking communication method in an Internet-free environment, according to an embodiment of the present application.

FIG. 2 is a schematic scene diagram of the networking communication method in the Internet-free environment according to an embodiment of the present application.

FIG. 3 is a structural block diagram of a networking communication system in an Internet-free environment according to an embodiment of the present application.

### DETAILED DESCRIPTION

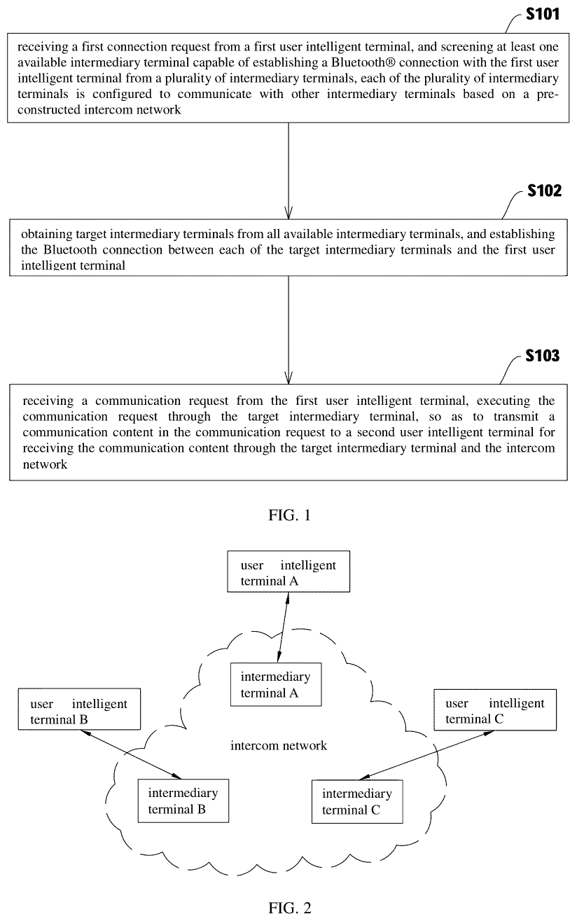

The present application is further described in detail below with reference to FIGS. 1-3.

An embodiment of the present application discloses a networking communication method in an Internet-free environment (hereinafter referred to simply as the networking communication method or networked communication method). An execution entity of the networked communication method may be a networking communication platform in the Internet-free environment (hereinafter referred to simply as the networking communication platform or networked communication system). The specific process steps for the networking communication platform to execute the networked communication method will be elaborated below based on FIGS. 1-2.

Step S101, receiving a first connection request from a first user intelligent terminal, and screening at least one available intermediary terminal capable of establishing a Bluetooth® connection with the first user intelligent terminal from a plurality of intermediary terminals, each of the plurality of intermediary terminals is configured to communicate with other intermediary terminals based on a pre-constructed intercom network.

Step S102, obtaining target intermediary terminals from all available intermediary terminals, and establishing the Bluetooth connection between each of the target intermediary terminals and the first user intelligent terminal.

Step S103, receiving a communication request from the first user intelligent terminal, executing the communication request through the target intermediary terminal, so as to transmit a communication content in the communication request to a second user intelligent terminal for receiving the communication content through the target intermediary terminal and the intercom network.

In practice, the user intelligent terminals (including the first user intelligent terminal and the second user intelligent terminal) refer to mobile phones or other mobile devices with built-in Bluetooth functions held by users, serving as communication control terminals. Each of these user intelligent terminals has a pre-developed APP application installed. Users can access the networking communication platform through a preset interactive interface of the application, and trigger requests on the interactive interface, such as the connection request mentioned above, which specifically refers to a Bluetooth connection request. After Bluetooth is activated by a user in advance and the connection request is initiated, the networking communication platform receives the connection request and obtains geographical location information of the user intelligent terminal by using a positioning modules integrated in the user intelligent terminal. Centered at this geographical location and with a radius equal to the maximum allowable Bluetooth connection distance, the platform defines a screening area and searches for available intermediary terminals within the screening area, and displays the searched intermediary terminals on the interactive interface of the user intelligent terminal, allowing the user to select available intermediary terminals from all the available intermediary terminals as the target intermediary terminals. The available intermediary terminals here refers to intermediary terminals that are currently not establishing the Bluetooth connection with any user intelligent terminal and are located within the screening area. In this embodiment, the intermediary terminal may be a walkie-talkie device with Bluetooth and WIoTa communication functions, which can be connected to the user intelligent terminal via Bluetooth and served as a main communication medium in a WIoTa private network. Correspondingly, the intercom network may support a WIoTa protocol.

As nodes of a WIoTa ad-hoc network, the intermediary terminals can relay and transmit data within the WIoTa ad-hoc network. After a user intelligent terminal establish the Bluetooth connection with a target intermediary terminal, the user intelligent terminal will join the WIoTa ad-hoc network. In other embodiments, the intercom network may support other communication protocols that enable communication and data transmission between the intercoms.

When a user needs to communicate with other users, the application may be used to trigger a communication request., The user enters communication content on the interactive interface of the application, and specifies recipient information for receiving the communication content, which may specifically include an ID of an intelligent mobile terminal of the recipient. Then, the networking communication platform receives the communication request with the communication content and recipient information, and determines an intermediary terminal connected to the intelligent mobile terminal of the recipient. By sending the communication content to the intermediary terminal connected to the intelligent mobile terminal of the recipient, which subsequently displays the communication content on the interactive interface of the application of the user intelligent terminal of the recipient. In this way, communication interaction between the user intelligent terminals is realized in the Internet-free environment by using the Bluetooth and the WIoTa ad-hoc network.

Correspondingly, the networking communication platform in the embodiment of the present application specifically includes:
a network protocol layer: including a Bluetooth universal network protocol and a WIoTa network communication protocol;
a network control layer: including a serving and packet data network gateway (SPGW), a network information server (NIS), and an access point (AP). The SPGW determines which NIS of service provider (SP) will receive the communication content based on the user ID (USER_ID). The NIS mainly completes encryption, authentication, compression and fragmentation of the communication content, as well as parsing its format. A service adaptation layer (SAL) in the NIS can parse the communication content and determine how to send it to an application server or adapt it to an IP layer. The AP is responsible for data interaction and management interaction between the air interface and IoTE, as well as interaction with the SPGW. The AP may be connected to one or more SPGWs to manage a message relay process and ensure that the communication content can be transmitted between the user intelligent terminals that are not directly connected.

A security and authentication layer: including an encryption module, an authentication module, and an intrusion detection system. The encryption module employs a Physical Unclonable Function (PUF)-based key management mechanism, combined with an AES128 data and code encryption engine, to encrypt the transmitted communication content and prevent unauthorized access to the communication content. The authentication module is configured to verify identity of the user intelligent terminal device, ensuring that only the authorized user intelligent terminal device can join the WIoTa network. The intrusion detection system is configured to monitor network activities, detect and respond to potential security threats.

In the “allowing the user to select available intermediary terminals from all the available intermediary terminals as the target intermediary terminals” mentioned above, the number of the target intermediary terminals may be one or more. If there are a plurality of target intermediary terminals, the networking communication platform may generate a connection relationship table, which stores IDs of the user intelligent terminals and all corresponding target intermediary terminals. When a user needs to communicate with other users, the networking communication platform receives a communication request containing the communication content and the recipient information. The communication request also include sender IDs, which are the IDs of the target intermediary terminals corresponding to the user intelligent terminal generating the communication request. This enables the user to specify any target intermediary terminal in the connection relationship table corresponding to their user intelligent terminals to transmit the communication content included in the current communication request. Subsequently, the networking communication platform simultaneously sends the communication content contained in the communication request to all target intermediary terminals corresponding to the sender IDs, so that the target intermediary terminals that receive the communication content forward the communication content to the intermediary terminals connected to recipient intelligent mobile terminals. Finally, a function that allows the users to specify one or more intermediary terminals to transmit the communication content is realized.

In other embodiments, the recipient information contained in the communication request mentioned above may contain a plurality of IDs of the recipient intelligent mobile terminals, enabling the delivery of communication content to a plurality of intelligent terminals. In addition, when triggering the communication request, the user may be provided with a broadcast function option by the networking communication platform. When the user select the broadcast function while triggering the communication request, the networking communication platform may send the communication content contained in the communication request to all non-available intermediary terminals at current moment upon receiving the communication request containing the communication content and the recipient information. That is, the networking communication platform may send the communication content to all intermediary terminals that have established the Bluetooth connection with the user intelligent terminal (hereinafter referred to as intermediary terminals X). This enables the intermediary terminals X to display the communication content on the interactive interfaces of the applications of the user intelligent terminals that have currently established the Bluetooth connection with them. This process ultimately realizes the function of mass-sending the communication content to all user intelligent terminals.

Optionally, the networking communication method further includes the following steps:

S104, determining a communication frequency of a first intermediary terminal that has established the Bluetooth connection with the first user intelligent terminal, and determining whether the first intermediary terminal satisfies a sharing condition;

S105, when the first intermediary terminal satisfies the sharing condition, designating the first intermediary terminal as one of second intermediary terminals, generating a connection object table for the second intermediary terminal, adding user intelligent terminals that have established the Bluetooth connections with the second intermediary terminal to the connection object table, and using the second intermediary terminal as an available intermediary terminal for real-time screening;

S106, when the second intermediary terminal being screened as a target intermediary terminal after receiving a second connection request, adding a user intelligent terminal triggering the second connection request into the connection object table corresponding to the second intermediary terminal; and

S107, determining in real time whether any user intelligent terminal in the connection object table has a communication demand, and switching the second intermediary terminal to establish the Bluetooth connection with a user intelligent terminal having the communication demand.

Optionally, the first intermediary terminal refers to an intermediary terminal that has established the Bluetooth connection with the first user intelligent terminal. the communication frequency of the first intermediary terminal transmitting communication content within a specified period is determined at regular intervals, and the communication frequency is used to characterize a frequency of communication. Exemplarily, determining whether the first intermediary terminal satisfies the sharing condition may specifically involve determining whether the first intermediary terminal has a shareable time period. The shareable time period refers to a time period during which the user intelligent terminal currently connected to the first intermediary terminal through the Bluetooth has no communication demand (hereinafter referred to as an idle period), and a duration of the idle period is greater than a preset duration.

The networking communication platform is configured to determine an average communication frequency based on the communication frequency of the first intermediary terminal, and predict future time points at which the first intermediary terminal will transmit the communication content based on a time point of the most recent transmission of the communication content and the average communication frequency. The time interval between adjacent time points constitutes an idle period.

When the first intermediary terminal has a shareable time period, that is, the first intermediary terminal satisfies the sharing condition, the first intermediary terminal is determined as one of the second intermediary terminals. The present application proposes generating the connection object table for the second intermediary terminal to store information of the user intelligent terminals that have established the Bluetooth connection with the second intermediary terminal (such as ID numbers of the user intelligent terminals). After subsequent connection requests are received and the screening area is determined, the second intermediary terminal will also be served as an available intermediary terminal. When displaying the available intermediary terminals for users to select, the networking communication platform may also display status information for each of the available intermediary terminals. The status information includes the number of the user intelligent terminals that are connected to the corresponding available intermediary terminals (i.e., the number of user intelligent terminals that are stored in the corresponding connection object table; when there is no connection object table, the number of the user intelligent terminals that are connected to the corresponding available intermediary terminals is zero), the communication frequency, and the shareable time period. This allows the user to select a unique target intermediary terminal based on the status information.

When the unique target intermediary terminal that is selected by the user from the available intermediary terminals is one of the second intermediary terminals, the user intelligent terminals that are held by the user will be added to the connection object table of the second intermediary terminal. Afterwards, it is determined in real time whether any user intelligent terminal in the connection object table corresponding to the second intermediary terminal has a communication demands (i.e., whether any user intelligent terminal has sent a communication request). When there is a communication demand, the second intermediary terminals will establish the Bluetooth connection with the user intelligent terminal having the communication demand, while other user intelligent terminals in the connection object table will actually be in a state of Bluetooth disconnection from the second intermediary terminals, i.e., a pseudo-connection state. In summary, all user intelligent terminals in the connection object table will share the second intermediary terminal corresponding to the connection object table, and the second intermediary terminal will switch in real-time to the Bluetooth connection with any user intelligent terminal in the connection object table that has a communication demand.

Optionally, the networking communication method further includes:
predicting in real time, time required to complete each communication request based on communication requests to be executed by the second intermediary terminals, and outputting a corresponding period for executing a communication request to a user intelligent terminal that issued the communication request upon each receipt of the communication request, and providing the user intelligent terminal that issued the communication request with options to select a processing scheme, wherein the processing scheme comprises at least maintaining the communication request and withdrawing the communication request.

In practice, as mentioned above, the user intelligent terminals in a same connection object table will share one second intermediary terminal. Therefore, when a plurality of user intelligent terminals submit the communication requests within a short period, the second intermediary terminal need to execute the corresponding communication requests in sequence according to submission time of the communication requests, which will inevitably result in some user intelligent terminals having to wait for connection. To address this, the present application provides that whenever the second intermediary terminal receives a communication request, it will predict the execution period of the communication request (the time interval consisting of a start time and an end time for executing the communication request). The specific prediction method is as follows: the end time of a latest execution period among all communication requests that the second intermediary terminal has not yet completed execution of as the start time of the execution period corresponding to the currently newly received communication request. The transmission duration required for the communication content is determined according to a size of a data packet of the communication content to be transmitted, and the end time is equal to a sum of the duration and the start time. In addition, the corresponding relationship between size ranges of the data packets of the communication content and their corresponding transmission durations may be pre-stored in the networking communication platform, and the transmission duration may be determined based on the corresponding relationship.

The users can select a processing scheme on the interactive interface according to the execution period, such as maintaining the communication request or withdrawing the communication request. When the user selects to maintain the communication request, the communication request will be added to a to-do list of the corresponding second intermediary terminal, so that the second intermediary terminal can execute communication requests in sequence according to an order in which they are added to the to-do list. When the user selects to withdraw the communication request, the networking communication platform will also display an inquiry on the corresponding interactive interface asking whether to replace the target intermediary terminal for the user to select. When the user selects to replace the target intermediary terminal, the user intelligent terminal corresponding to the user will be deleted from the connection object table of the corresponding second intermediary terminal, and the connection request will be re-triggered and generated for the user intelligent terminal, so as to re-screen available intermediary terminals for the user intelligent terminal.

Optionally, the networking communication method further includes the following steps after step S107:

S108, predicting an active period for each of user intelligent terminals in a connection object table corresponding to each of the second intermediary terminals based on an activity frequency of the respective user intelligent terminals, wherein the activity frequency characterizes a frequency of initiating communication requests by a corresponding user intelligent terminal, the active period refers to a period during which the corresponding user intelligent terminal initiates the communication requests; and

S109, screening a fourth intermediary terminal for each of target user intelligent terminals having overlapping active periods, establishing a Bluetooth connection between the fourth intermediary terminal and the target user intelligent terminal during a corresponding active period, to enable the fourth intermediary terminal to execute communication requests from the target user intelligent terminal during the active period.

Wherein, S109 specifically includes the following steps:
determining associated user intelligent terminals corresponding to the target user intelligent terminal, wherein the associated user intelligent terminals are user intelligent terminals that have received communication content in communication requests transmitted by the target user intelligent terminals during a historical period, or have sent communication content in the communication requests to the target user intelligent terminal during the historical period;
predicting an activity range of the target user intelligent terminal and activity ranges of the associated user intelligent terminals based on movement trajectories of the target user intelligent terminal and the associated user intelligent terminals, and determining intersection areas between the activity range of the target user intelligent terminal and an activity range of each of the associated user intelligent terminals;
determining an intermediary terminal having a largest overlapping part between a Bluetooth coverage range and a corresponding intersection area for each of the associated user intelligent terminals; and
sending terminal information of each of the associated user intelligent terminals and terminal information of a corresponding intermediary terminal to the target user intelligent terminal, so that the target user intelligent terminal selects the fourth intermediary terminal.

In an embodiment, the activity frequency of a user intelligent terminal refers to the frequency at which the user intelligent terminal initiates the communication requests, and the active period of a user intelligent terminal corresponds to the execution period of its communication requests. The networking communication platform is configured to compare the active periods of all user intelligent terminals in the same connection object table and determine whether there are user intelligent terminals (i.e., target user intelligent terminals) whose active periods overlap. When such user intelligent terminals exist, screening for the fourth intermediary terminal, and selecting, from two target user intelligent terminals with overlapping periods, the one whose overlapping portion accounts for a large proportion of its corresponding active period. During the active periods of the target user intelligent terminal, the Bluetooth connection is established between the target user intelligent terminal and the fourth intermediary terminal, so that during the active period, the fourth intermediary terminal is used to execute the communication requests of the target user intelligent terminal. That is, for two target user intelligent terminals A and B with overlapping active periods, the fourth intermediary terminal is screened to execute the communication requests initiated by the target user intelligent terminals A or B during their active periods. This avoids the communication requests being too concentrated, which may affect timeliness of the communication.

The screening method for the fourth intermediary terminal is specifically as follows: Firstly, determining the associated user intelligent terminals corresponding to the target user intelligent terminal that needs to establish connections with the fourth intermediary terminal. The associated user intelligent terminals refer to user intelligent terminals that have communicated with the target user intelligent terminal in the historical periods. Therefore, there may be several associated user intelligent terminals. That is, the objects with which the target user intelligent terminal intends to communicate are identified by screening historical communication requests.

Secondly, determining the movement trajectories of the target user intelligent terminal and the associated user intelligent terminals respectively based on location information thereof; delineating the activity ranges of the target user intelligent terminal and the associated user intelligent terminals according to the movement trajectories thereof, ensuring that the activity ranges cover the corresponding movement trajectories. The intersection area of the activity ranges between the target user intelligent terminals and each of the associated user intelligent terminals may be determined. Subsequently, for each of the associated user intelligent terminals, the intermediary terminal with the largest overlapping portion between the Bluetooth coverage range and the corresponding intersection area is selected as the intermediary terminal corresponding to the associated intelligent terminal. Finally, each of the associated user intelligent terminals and their corresponding intermediary terminals may be displayed on the interactive interface of the target user intelligent terminal, along with inquiry information for the user to select associated user intelligent terminals to be communicated with. Afterward, an intermediary terminal corresponding to the associated user intelligent terminal selected by the user is designated as the fourth intermediary terminal.

Optionally, the networking communication method further includes the following steps:
generating and storing a corresponding communication record upon receiving the communication request, the communication record at least comprises the terminal information of user intelligent terminals each having a communication relationship, wherein the user intelligent terminals each having the communication relationship comprise a user intelligent terminal initiating the communication request and a user intelligent terminal receiving the communication content in the communication request;
determining whether there exists a third intermediary terminal among the second intermediary terminals based on each communication record, wherein a distance between the third intermediary terminal and each of the user intelligent terminals each having the communication relationship satisfies requirements for the Bluetooth connection;
upon determining existence of the third intermediary terminal, sending a connection application to a user intelligent terminal having the communication relationship in a corresponding communication record and satisfying the requirements for the Bluetooth connection with the third intermediary terminal, after the corresponding user intelligent terminal approves the connection application, adding the corresponding user intelligent terminal to the connection object table of the third intermediary terminal, and establishing a first storage space for user intelligent terminals each having the communication relationship in the connection object table;
upon receiving a communication request sent from one to another among the user intelligent terminals each having the communication relationship, storing the communication content in the communication request in the corresponding first storage space, so that when the third intermediary terminal establishes the Bluetooth connection with a user intelligent terminal for receiving the communication content in the communication request, the user intelligent terminal receiving the communication content in the communication request is enabled to read the communication content that is stored in the corresponding first storage space.
when new communication content is added to any first storage space, searching for a second intermediary terminal corresponding to the first storage space and a user intelligent terminal for receiving the new communication content in the first storage space, sending a reverse connection application to the searched user intelligent terminal, with priority given to transmission via the searched second intermediary terminal;
upon receiving a communication request when no intermediary terminal currently maintains a Bluetooth connection with a user intelligent terminal for receiving communication content in the communication request, generating a second storage space and sending the reverse connection application to the user intelligent terminal for receiving the communication content in the communication request; and
upon approval of the reverse connection application by the user intelligent terminal for receiving the communication content in the communication request, establishing the Bluetooth connection to enable the user intelligent terminal for receiving the communication content in the communication request to read the communication content in the corresponding first storage space or the second storage space.

In an embodiment, a user intelligent terminal sending a communication request and a user intelligent terminal receiving communication content in the communication request are referred to as user intelligent terminals having a communication relationship. The networking communication platform may screen out a third intermediary terminal for the user intelligent terminals having the communication relationship and submit a connection application to the user intelligent terminal having the communication relationship. After the connection application is approved, the information of both user intelligent terminals having the communication relationship will be simultaneously stored in the connection object table of the third intermediary terminal. Additionally, a first storage space is separately set up in the third intermediary terminal to store the communication content in the communication request sent by either party of the user intelligent terminal having the communication relationship to the other party.

Whenever a communication request from either user intelligent terminal mentioned above is received, the networking communication platform temporarily stores communication content in a corresponding first storage space, and prompts the other user intelligent terminal to read the communication content in the first storage space when the Bluetooth connection with the third intermediary terminal is established.

A screening criteria for the third intermediary terminal may be as follows: distances between each of the user intelligent terminals having the communication relationship in a target communication record and the third intermediary terminal satisfy the Bluetooth connection requirements; or the Bluetooth coverage range overlaps with the activity range of each of the user intelligent terminals having the communication relationship, and the overlapping area is the largest. The target communication record refers to any communication record.

In addition, in order to allow the other user intelligent terminal to read the communication content in the first storage space as soon as possible, the present application proposes that after new communication content is added to the first storage space and the temporary storage of the communication content is completed, the third intermediary terminal will actively display the reverse connection application on the interactive interface of the application of the other user intelligent terminal. This allows the user to select whether to establish the Bluetooth connection with the third intermediary terminal. When approved, the Bluetooth connection will be established between the user intelligent terminal and the third intermediary terminal, enabling the other user intelligent terminal to read the communication content in the corresponding first storage space.

In addition, whenever a communication request is received and there is currently no intermediary terminal Bluetooth-connected to the user intelligent terminal intended to receive the communication content in the communication request, a second storage space may be set up in the first intermediary terminal connected to the user intelligent terminal sending the communication request, and the corresponding communication content is stored in the corresponding second storage space. At this time, the first intermediary terminal sends the reverse connection application to the user intelligent terminal intended to receive the communication content in the communication request. After the user intelligent terminal approves the reverse connection application, the Bluetooth connection is established to allow the user intelligent terminal to read the communication content in the second storage space. The connection is disconnected after the reading is completed.

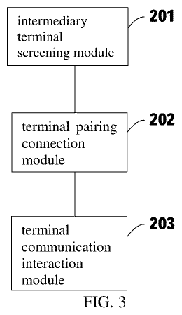

The embodiment of the present application further discloses the networking communication platform in the Internet-free environment. Referring to FIG. 3, the networking communication platform includes:
an intermediary terminal screening module 201, configured to receive a first connection request from a first user intelligent terminal, screen at least one available intermediary terminal capable of establishing a Bluetooth connection with the first user intelligent terminal from a plurality of intermediary terminals, wherein each of the plurality of intermediary terminals is configured to communicate with other intermediary terminals based on a pre-constructed intercom network; the intermediary terminal screening module 201 may be implemented as a microcontroller.
a terminal pairing connection module 202, configured to obtain target intermediary terminals from all available intermediary terminals and establish the Bluetooth connection between each of the target intermediary terminals and the first user intelligent terminal; the terminal pairing connection module 202 may be implemented as a Bluetooth communication protocol stack, an integrated Bluetooth chip, a pairing management library, a pairing algorithm module, or a secure pairing module.
a terminal communication interaction module 203, configured to receive a communication request from the first user intelligent terminal, execute the communication requests through the target intermediary terminals, so as to transmit communication content in the communication request to a second user intelligent terminal for receiving the communication content through the intercom network based on terminal information contained in the communication request; the terminal communication interaction module 203 may be implemented as a communication module.
a shared relationship establishment module, configured to determine a communication frequency of the first intermediary terminal that has established the Bluetooth connection with the first user intelligent terminal, and determine whether the first intermediary terminal satisfies a sharing condition; when the first intermediary terminal satisfies the sharing condition, designate the first intermediary terminal as one of second intermediary terminals; generate the connection object table for the second intermediary terminal, add user intelligent terminals that have established the Bluetooth connections with the second intermediary terminal to the connection object table, and using the second intermediary terminal as an available intermediary terminal for real-time screening.

In addition, the shared relationship establishment module is further configured to add a user intelligent terminal triggering a second connection request into the connection object table corresponding to the second intermediary terminal when the second intermediary terminals being screened as a target intermediary terminal after receiving the second connection request; and the shared relationship establishment module is further configured to determine in real time whether any user intelligent terminal in the connection object table have a communication demand, and switch the second intermediary terminal to establish the Bluetooth connection with a user intelligent terminal having the communication demand. An embodiment of the present application further discloses a networking communication device in the Internet-free environment, the networking communication device in the Internet-free environment includes a memory and a processor, the memory stores a computer program that can be loaded by the processor, and when the computer program is run by the processor, it executes the networking communication method in the Internet-free environment mentioned above. In an embodiment, the shared relationship establishment module may be implemented as a connection management module, etc.

Each of the intermediary terminal screening module 201, the terminal pairing connection module 202, the terminal communication interaction module 203, and the shared relationship establishment module included in the networking communication platform mentioned above may be implemented by the processor running the computer program.

The embodiment of the present application also discloses a computer-readable storage medium, which stores the computer program that can be loaded by the processor and executing the networked communication method in the Internet-free environment mentioned above. The computer-readable storage medium includes, for example: a USB flash drive, a mobile hard drive, a Read-Only Memory (ROM), a Random Access Memory (RAM), a magnetic disk, or an optical disk, and other media that can store program codes.

It should be noted that, relational terms such as “first” and “second” herein are only used to distinguish one entity or operation from another entity or operation, and do not necessarily require or imply that there is any actual relationship or sequence between these entities or operations.

### LIST OF REFERENCE NUMERALS:

201. intermediary terminal screening module;
202. terminal pairing connection module;
203. terminal communication interaction module.

What is claimed is:

1. A networking communication method in an Internet-free environment, comprising:
receiving a first connection request from a first user intelligent terminal, and screening at least one available intermediary terminal capable of establishing a Bluetooth connection with the first user intelligent terminal from a plurality of intermediary terminals, wherein each of the plurality of intermediary terminals is configured to communicate with other intermediary terminals based on a pre-constructed intercom network;
obtaining target intermediary terminals from all available intermediary terminals, and establishing the Bluetooth connection between each of the target intermediary terminals and the first user intelligent terminal; and
receiving a communication request from the first user intelligent terminal, executing the communication request through the target intermediary terminal, so as to transmit communication content in the communication request to a second user intelligent terminal for receiving the communication content through the pre-constructed intercom network based on terminal information contained in the communication request;
wherein, the networking communication method further comprises:
determining a communication frequency of a first intermediary terminal that has established the Bluetooth connection with the first user intelligent terminal, and determining whether the first intermediary terminal satisfies a sharing condition;
when the first intermediary terminal satisfies the sharing condition, designating the first intermediary terminal as one of second intermediary terminals, generating a connection object table for the second intermediary terminal, adding user intelligent terminals that have established the Bluetooth connections with the second intermediary terminal to the connection object table, and using the second intermediary terminal as an available intermediary terminal for real-time screening;
when the second intermediary terminal is screened as a target intermediary terminal after receiving a second connection request, adding a user intelligent terminal triggering the second connection request into the connection object table corresponding to the second intermediary terminal; and
determining in real time whether any user intelligent terminal in the connection object table has a communication demand, and switching the second intermediary terminal to establish the Bluetooth connection with a user intelligent terminal having the communication demand.

2. The networking communication method in the Internet-free environment according to claim 1, further comprising:
generating and storing a corresponding communication record upon receiving the communication request, the communication record at least comprises the terminal information of user intelligent terminals each having a communication relationship, wherein the user intelligent terminals each having the communication relationship comprise a user intelligent terminal initiating the communication request and a user intelligent terminal receiving the communication content in the communication request;
determining whether there exists a third intermediary terminal among the second intermediary terminals based on each communication record, wherein a distance between the third intermediary terminal and each of the user intelligent terminals each having the communication relationship satisfies requirements for the Bluetooth connection;
upon determining existence of the third intermediary terminal, sending a connection application to a user intelligent terminal having the communication relationship in a corresponding communication record and satisfying the requirements for the Bluetooth connection with the third intermediary terminal, after the corresponding user intelligent terminal approves the connection application, adding the corresponding user intelligent terminal to the connection object table of the third intermediary terminal, and establishing a first storage space for user intelligent terminals each having the communication relationship in the connection object table; and
upon receiving a communication request sent from one to another among the user intelligent terminals each having the communication relationship, storing the communication content in the communication request in the corresponding first storage space, so that when the third intermediary terminal establishes the Bluetooth connection with a user intelligent terminal for receiving the communication content in the communication request, the user intelligent terminal receiving the communication content in the communication request is enabled to read the communication content that is stored in the corresponding first storage space.

3. The networking communication method in the Internet-free environment according to claim 2, further comprising:
when new communication content is added to any first storage space, searching for a second intermediary terminal corresponding to the first storage space and a user intelligent terminal for receiving the new communication content in the first storage space, sending a reverse connection application to the searched user intelligent terminal, with priority given to transmission via the searched second intermediary terminal;
upon receiving a communication request when no intermediary terminal currently maintaining a Bluetooth connection with a user intelligent terminal for receiving communication content in the communication request, generating a second storage space and sending the reverse connection application to the user intelligent terminal for receiving the communication content in the communication request; and
upon approval of the reverse connection application by the user intelligent terminal for receiving the communication content in the communication request, establishing the Bluetooth connection to enable the user intelligent terminal for receiving the communication content in the communication request to read the communication content in the corresponding first storage space or the second storage space.

4. The networking communication method in the Internet-free environment according to claim 1, further comprising: after determining in real time whether any user intelligent terminal in the connection object table has the communication demand, and switching the second intermediary terminal to establish the Bluetooth connection with the user intelligent terminal having the communication demand,
predicting an active period for each of user intelligent terminals in a connection object table corresponding to each of the second intermediary terminals based on an activity frequency of the respective user intelligent terminals, wherein the activity frequency characterizes a frequency of initiating communication requests by a corresponding user intelligent terminal, and the active period refers to a period during which the corresponding user intelligent terminal initiates the communication requests; and
screening a fourth intermediary terminal for each of target user intelligent terminals having overlapping active periods, and establishing a Bluetooth connection between the fourth intermediary terminal and the target user intelligent terminal during a corresponding active period, to enable the fourth intermediary terminal to execute communication requests from the target user intelligent terminal during the active period.

5. The networking communication method in the Internet-free environment according to claim 4, wherein screening the fourth intermediary terminal for each of the target user intelligent terminals, comprises:
determining associated user intelligent terminals corresponding to the target user intelligent terminal, wherein the associated user intelligent terminals are user intelligent terminals that have received communication content in communication requests transmitted by the target user intelligent terminals during a historical period, or have sent communication content in the communication requests to the target user intelligent terminal during the historical period;
predicting an activity range of the target user intelligent terminal and activity ranges of the associated user intelligent terminals based on movement trajectories of the target user intelligent terminal and the associated user intelligent terminals, and determining intersection areas between the activity range of the target user intelligent terminal and an activity range of each of the associated user intelligent terminals;
determining an intermediary terminal having a largest overlapping part between a Bluetooth coverage range and a corresponding intersection area for each of the associated user intelligent terminals; and
sending terminal information of each of the associated user intelligent terminals and terminal information of a corresponding intermediary terminal to the target user intelligent terminal, so that the target user intelligent terminal selects the fourth intermediary terminal.

6. The networking communication method in the Internet-free environment according to claim 2, further comprising:
predicting in real time, time required to complete each communication request based on communication requests to be executed by the second intermediary terminals, outputting a corresponding period for executing a communication request to a user intelligent terminal that issued the communication request upon each receipt of the communication request, and providing the user intelligent terminal that issued the communication request with options to select a processing scheme, wherein the processing scheme comprises at least maintaining the communication request and withdrawing the communication request.

7. A networking communication platform in an Internet-free environment, comprising:
an intermediary terminal screening module, configured to receive a first connection request from a first user intelligent terminal, and screen at least one available intermediary terminal capable of establishing a Bluetooth connection with the first user intelligent terminal from a plurality of intermediary terminals, wherein each of the plurality of intermediary terminals is configured to communicate with other intermediary terminals based on a pre-constructed intercom network;
a terminal pairing connection module, configured to obtain target intermediary terminals from all available intermediary terminals and establish the Bluetooth connection between each of the target intermediary terminals and the first user intelligent terminal;
a terminal communication interaction module, configured to receive a communication request from the first user intelligent terminal, and execute the communication requests through the target intermediary terminals, so as to transmit communication content in the communication request to a second user intelligent terminal for receiving the communication content through the pre-constructed intercom network based on terminal information contained in the communication request; and
a shared relationship establishment module, configured to determine a communication frequency of a first intermediary terminal that has established the Bluetooth connection with the first user intelligent terminal, determine whether the first intermediary terminal satisfies a sharing condition; when the first intermediary terminal satisfies the sharing condition, designate the first intermediary terminal as one of second intermediary terminals, generate a connection object table for the second intermediary terminal, add user intelligent terminals that have established the Bluetooth connections with the second intermediary terminal to the connection object table, and use the second intermediary terminal as an available intermediary terminal for real-time screening; the shared relationship establishment module is further configured to add a user intelligent terminal triggering a second connection request into the connection object table corresponding to the second intermediary terminal when the second intermediary terminals being screened as a target intermediary terminal after receiving the second connection request; and the shared relationship establishment module is further configured to determine in real time whether any user intelligent terminal in the connection object table have a communication demand, and switch the second intermediary terminal to establish the Bluetooth connection with a user intelligent terminal having the communication demand.
